(19) United States
(12) Patent Application Publication
(10) Pub. No.: US 2012/0100812 A1
(43) Pub. Date: Apr. 26, 2012

(54) MOBILE COMMUNICATION METHOD AND DEVICE THEREOF

(75) Inventors: Wen-Yi Kuo, Taipei City (TW); Jui-Ming Yu, Taipei County (TW)

(73) Assignee: BANDRICH INC., TAIPEI COUNTY (TW)

(21) Appl. No.: 13/380,848

(22) PCT Filed: Jun. 25, 2009
(86) PCT No.: PCT/CN09/72445

§ 371 Date: Dec. 25, 2011

(51) Int. Cl. H04W 24/00

(52) U.S. Cl. 455/67.11

(57) ABSTRACT

A mobile communication method includes the following steps: local base station information of at least one local base station is received from the at least one local base station. When present mode is under test mode, connection information is obtained to replace the local base station information. A test connection to one of the at least one local base station is established according to the connection information to obtain mobile communication service through the test connection.

### RELATED APPLICATIONS

This application is a co-pending application, which claims priority to PCT Application No. PCT/CN2009/072445 filed Jun. 25, 2009, which are herein incorporated by reference.

### BACKGROUND

1. Technical Field

The present invention relates to a communication method and device thereof. More particularly, the present invention relates to a mobile communication method and device thereof.

2. Description of Related Art

As technology develops and mobile communication devices (such as cellular phones) become cheaper, mobile communication devices are widely spread. Mobile communication devices may provide convenience for life and work. In addition, several new and attractive appearances and structures are designed for mobile communication devices to satisfy users' different needs. Therefore, mobile communication devices become part of human's life. Most people take mobile communication devices with them all the time.

Before connecting to mobile communication network, normal mobile communication devices would receive base station information, such as cell selection parameters, broadcasted by local base stations. Then, mobile communication devices select one of local base stations according to the received base station information to obtain mobile communication services. Therefore, broadcasted base station information may affect connection quality provided to mobile communication devices.

In prior art, to test connection quality utilizing different base station information, base station information under test may be broadcasted at midnight. However, there are still some users utilizing mobile communication devices at midnight, which may still be interfered by such test.

### SUMMARY

According to one embodiment of this invention, a mobile communication method is provided. Under the test mode, the mobile communication method obtains the mobile communication service according to information, which is not received from the base station. The mobile communication method includes the following steps: local base station information of at least one local base station is received from the at least one local base station. Connection information is obtained to replace the local base station information when present mode is under test mode. A test connection is established to one of the at least one local base station according to the connection information to obtain mobile communication service through the test connection.

According to one embodiment of this invention, a mobile communication device is provided. Under the test mode, the mobile communication device obtains the mobile communication service according to information, which is not received from the base station. The mobile communication device includes a mobile communication unit and a processing unit. The mobile communication unit receives local base station information of at least one local base station from the at least one local base station. The processing unit includes a test module and a determining module. The test module obtains connection information to replace the local base station information when present mode of the mobile communication device is under test mode, and establishes a test connection to one of the at least one local base station according to the connection information. The determining module determines which mode the present mode is under. The determining module makes the mobile communication device utilize the test module to obtain mobile communication service through the test connection when the present mode is determined under the test mode.

Above all, the mobile communication service can be obtained according to the information, which is not received from the broadcast of the local base station. In addition, the status of the test connection, which is established according to the connection information, is recorded for analysis of different connection information. Hence, the mobile communication device can be utilized to test connection status according to different connection information, which is not broadcasted by the base stations. In other words, it's not necessary that base stations broadcast connection information for test, which can avoid interfering mobile communication services provided to other users. In addition, during test for connection information corresponding to different base stations, identification information of base stations may be utilized to query the connection information corresponding to the base station, and the queried connection information may be utilized for establishing connection to the corresponding base station for test. Besides, information broadcasted by base station may be utilized for connection as other normal mobile communication devices does when the present mode is under normal mode.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a mobile communication method according to one embodiment of this invention; and

FIG. 2 is a block diagram of a mobile communication device according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

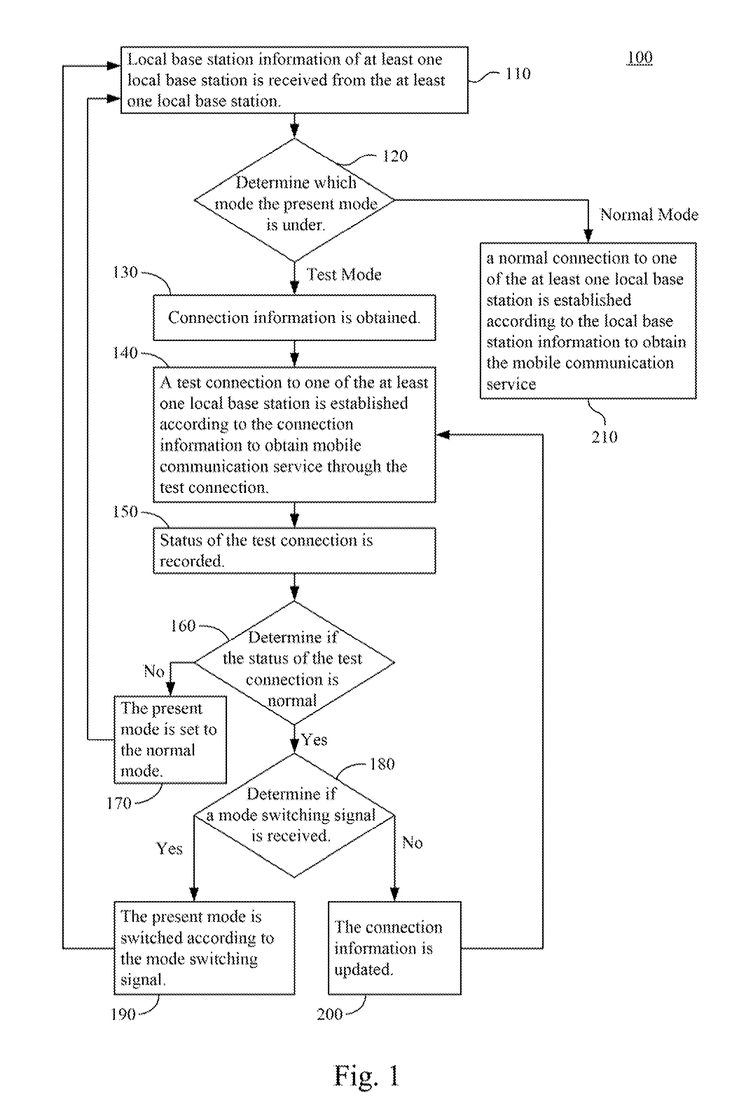

FIG. 1 is a flow diagram of a mobile communication method according to one embodiment of this invention. The mobile communication method can be applied to any mobile communication technology, such as 2^{nd} Generation (2G), 3rd Generation (3G) or any other mobile communication technology. Under the test mode, the mobile communication method obtains the mobile communication service according to information, which is not received from the base station. The mobile communication method includes the following steps:

In step 110, local base station information of at least one local base station is received from the at least one local base station. Wherein, the received local base station information is the information, which the at least one local base station keeps broadcasting. The local base station information may include identification information, location information, group information, connection information or any other base station related information of the local base station, which broadcast the local base station information.

In step 120, determine which mode the present mode is under. When the present mode is determined under the normal mode, a normal connection to one of the at least one local base station is established according to the local base station information to obtain the mobile communication service (step 210).

When the present mode is determined under the test mode, connection information is obtained (step 130) to replace the local base station information. Wherein, the connection information may include a cell selection parameter. The connection information may be obtained through a user interface or obtained from a computer through a computer transmission interface of the computer. The user interface may be a keyboard, a touch panel or any other user interface. The computer transmission interface may be Universal Serial Port (USB), Universal Asynchronous Receiver/Transmitter (UART), PCI Express or any other computer transmission interface. Therefore, users can set the connection information through the user interface or through a computer.

In addition, identification information of the at least one base station may be obtained from the at least one base station for querying a database according to the identification information of the at least one base station to obtain the connection information. Wherein, the identification information of the at least one base station utilized for query may be the identification number of the at least one base station, the information of the group which the at least to one base station belongs to, the information of the location which the at least one base station is located at or any other information utilized for identification. In other words, several different types of the identification information can be utilized to obtain the corresponding connection information.

In step 140, a test connection to one of the at least one local base station is established according to the connection information to obtain mobile communication service through the test connection. Therefore, the mobile communication service can be obtained according to information, which is not broadcasted by the local base station, when the present mode is under the test mode.

In addition, in step 150, status of the test connection is recorded. Therefore, the status of the test connection, which established according to the connection information, can be recorded.

In step 160, determine if the status of the test connection is normal. Wherein, the status of the test connection may be determined abnormal when several continual connection interruptions occur or the base station to be connected is busy.

When the status of the test connection is abnormal, the present mode is set to the normal mode (step 170). Then, the local base station information of the at least one local base station is received again (step 110), and determine the present mode (step 120) to switch to the normal mode. Therefore, if the mobile communication service can not be obtained under the test mode, the mobile communication service may be obtained by switching to the normal mode.

When the status of the test connection is normal, determine if a mode switching signal is received (step 180). When the mode switching signal is received, the present mode is switched according to the mode switching signal (step 190). Then, the local base station information of the at least one local base station is received again (step 110), and determine the present mode (step 120) for mode switching. Wherein the mode switching signal may be received through a user interface or received from a computer through a computer transmission interface of the computer. The user interface may be a keyboard, a touch panel or any other user interface. The computer transmission interface may be USB, UART, PCI Express or any other computer transmission interface. Therefore, users can switch the present mode through the user interface or through a computer.

In addition, when no mode switching signal is received, the connection information may be updated (step 200), and a test connection to one of the at least one local base station is established according to the connection information to obtain mobile communication service through the test connection (step 140). Wherein, an update short message, which includes an update for the connection information, may be received through short message service to update the connection information (step 200) according to the update for the connection information. Besides, Internet may be connected through the mobile communication service, and an update packet, which includes an update for the connection information, may be received through Internet. Then, the connection information is updated according to the update for the connection information included in the update packet. Therefore, users can update the connection information remotely through the short message service or Internet.

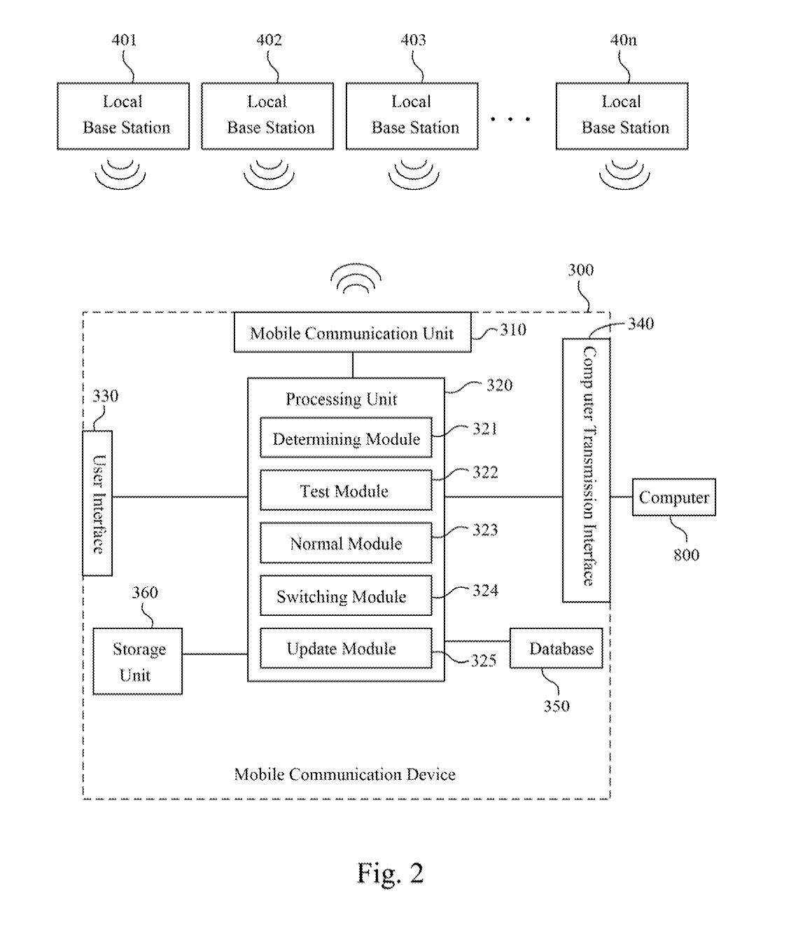

FIG. 2 is a block diagram of a mobile communication device according to one embodiment of this invention. Under the test mode, the mobile communication device obtains the mobile communication service according to information, which is not received from the base station. The mobile communication device 300 includes a mobile communication unit 310 and a processing unit 320. The mobile communication unit 310 receives local base station information of at least one local base station 401,402, . . . , 40n from the at least one local base station 401,402, . . . , 40n. The processing unit 320 includes a determining module 321 and a test module 322. The test module 322 obtains connection information to replace the local base station information of the at least one local base station 401,402, . . . , 40n when present mode of the mobile communication device is under test mode. The test module 322 establishes a test connection to one of the at least one local base station 401,402, . . . , 40n according to the connection information. For example, the test module 322 may select the local base station 402 according to the connection information and establish the test connection to the selected local base station 402. Wherein, the test connection to the selected local base station 402 may be established through the mobile communication unit 310.

The determining module 321 determines which mode the present mode of the mobile communication device 300 is under. When the present mode of the mobile communication device 300 is determined under the test mode, the determining module 321 makes the mobile communication device 300 utilize the test module to obtain mobile communication service through the test connection. The mobile communication unit 310 may utilize any mobile communication technology, such as 2G, 3G or any other mobile communication technology, to obtain the mobile communication service. Therefore, the mobile communication device 300 can obtain the mobile communication service according to information, which is not received from the base station.

The test module 322 may obtain the connection information in several ways. For example, the test module 322 may obtain the connection information through a user interface 330 of the mobile communication device 300. The user interface 330 may be a keyboard, a touch panel or any other user interface. In addition, the mobile communication device 300 may further include a computer transmission interface 340 to build a connection with a computer 800, and the connection information may be obtained from the computer 800 through the computer transmission interface 340. The computer transmission interface 340 may be USB, UART, PCI Express or any other computer transmission interface. Therefore, users can set the connection information through the user interface 330 or by utilizing a computer 800.

In addition, the test module 322 may obtain identification information of the at least one base station 401, 402, . . . , 40n for querying a database according to the identification information of the at least one base station 401, 402, . . . , 40n to obtain the connection information. Wherein, the identification information of the at least one base station 401, 402, . . . , 40n utilized for query may be the identification number of the at least one base station 401, 402, . . . , 40n, the information of the group which the at least one base station 401, 402, . . . , 40n belongs to, the information of the location which the at least one base station 401, 402, . . . , 40n is located at or any other information utilized for identification. In other words, the test module 322 may utilize several different types of the identification information to obtain the corresponding connection information.

When the mobile communication device 300 utilizes the test module 322 to establish a test connection, the test module 322 may analyze status of the test connection and records the status of the test connection in a storage unit 360 of the mobile communication device 300. Therefore, the status of the test connection, which is established according to the connection information, may be recorded.

Besides, after the mobile communication device utilizes the test module to obtain the mobile communication service, the connection information, which the test module establishes the test connection according to, can be updated dynamically. Therefore, the processing unit 320 may further include an update module 325 to update the connection information dynamically. In one embodiment, an update short message, which includes an update for the connection information, may be received through short message service of the mobile communication service by the mobile communication unit 310, the update module 325 may update the connection information according to the update for the connection information. In another embodiment, the mobile communication unit 310 may connect to Internet through the mobile communication service and an update packet, which includes an update for the connection information, may be received through Internet, and the update module 325 updates the connection information according to the update for the connection information included in the update packet. Therefore, users can update the connection information remotely through short message service or Internet.

The processing unit 320 may further include a normal module 323 to establish a normal connection to one of the at least one local base station 401, 402, . . . , 40n according to the local base station information received from the at least one local base station 401, 402, . . . , 40n to obtain the mobile communication service. For example, the normal module 323 may select the local base station 403 according to the local base station information received from the at least one local base station 401, 402, . . . , 40n, and establishes the normal connection to the selected local base station 403. Wherein, the normal connection to the selected local base station 403 may be established through the mobile communication unit 310. In other embodiments, the test module 322 and the normal module 323 may select the same local base station for connection, which should not be limited in this disclosure. Besides, the determining module 321 makes the mobile communication device utilize the normal module 323 to obtain the mobile communication service when the present mode of the mobile communication device 300 is under the normal mode. Therefore, when the present mode is under the normal mode, the mobile communication device 300 can obtain the mobile communication service according to the information received from the at least one local base station 401, 402, . . . , 40n as other normal mobile communication devices does.

In addition, the mobile communication device 300 may utilize the determining module 321 to determine if status of the test connection is normal. Wherein, the determining module 321 may determine the status of the test connection abnormal when several continual connection interruptions occur or the local base station to be connected is busy. When the determining module 321 determines that the status of the test connection is abnormal, a switching module 324 of the processing unit 320 switches the present mode to the normal mode, such that the mobile communication device 300 utilizes the normal module 323 to obtain the mobile communication service. Therefore, if the mobile communication device 300 can not obtain the mobile communication service utilizing the test module 322, the mobile communication device 300 can still utilize the normal module 323 to obtain the mobile communication service.

The mobile communication device 300 may switch between the normal mode and the test mode to obtain the mobile communication service. Therefore, when a mode switching signal is received, the switching module 324 switches the present mode according to the received mode switching signal. The determining module 321 selects one of the normal module 323 and the test module 322 to obtain the mobile communication service according to the switched present mode. Wherein, the mode switching signal may be received through the user interface 330, the computer transmission interface 340, short message service or Internet. Hence, users can make the mobile communication device 300 between the normal mode and the test mode.

Above all, the mobile communication service can be obtained according to the information, which is not received from the broadcast of the local base station. In addition, the status of the test connection, which is established according to the connection information, is recorded for analysis of different connection information. Hence, the mobile communication device can be utilized to test connection status according to different connection information, which is not broadcasted by the base stations. In other words, it's not necessary that base stations broadcast connection information for test, which can avoid interfering mobile communication services provided to other users. In addition, during test for connection information corresponding to different base stations, identification information of base stations may be utilized to query the connection information corresponding to the base station, and the queried connection information may be utilized for establishing connection to the corresponding base station for test. Besides, information broadcasted by base station may be utilized for connection as other normal mobile communication devices does when the present mode is under normal mode.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A mobile communication method, comprising:
receiving local base station information of at least one local base station from the at least one local base station;
obtaining connection information to replace the local base station information when present mode is under test mode; and
establishing a test connection to one of the at least one local base station according to the connection information to obtain mobile communication service through the test connection.

2. The mobile communication method of claim 1, further comprising:
establishing a normal connection to one of the at least one local base station according to the local base station information to obtain the mobile communication service when the present mode is under normal mode.

3. The mobile communication method of claim 2, further comprising:
determining if the status of the test connection is normal; and
switching to the normal mode if the status of the test connection is abnormal.

4. The mobile communication method of claim 1, further comprising:
recording status of the test connection.

5. The mobile communication method of claim 1, wherein obtaining the connection information comprises:
obtaining identification information of the at least one base station from the at least one base station; and
querying a database according to the identification information of the at least one base station to obtain the connection information.

6. The mobile communication method of claim 1, wherein obtaining the connection information comprises:
receiving the connection information through a user interface.

7. The mobile communication method of claim 1, wherein obtaining the connection information comprises:
receiving the connection information through a computer transmission interface of a computer.

8. The mobile communication method of claim 1, further comprising:
receiving an update short message through short message service, wherein the update short message comprises an update for the connection information; and
updating the connection information according to the update for the connection information.

9. The mobile communication method of claim 1, further comprising:
connecting to Internet through the mobile communication service;
receiving an update packet through Internet, wherein the update packet comprises an update for the connection information; and
updating the connection information according to the update for the connection information.

10. The mobile communication method of claim 1, further comprising:
when a mode switching signal is received, switching the present mode according to the mode switching signal.

11. A mobile communication device, comprising:
a mobile communication unit, wherein the mobile communication unit receives local base station information of at least one local base station from the at least one local base station; and
a processing unit, comprising:
a test module, obtaining connection information to replace the local base station information when present mode of the mobile communication device is under test mode, and establishing a test connection to one of the at least one local base station according to the connection information; and
a determining module, determining which mode the present mode is under, wherein the determining module makes the mobile communication device utilize the test module to obtain mobile communication service through the test connection when the present mode is determined under the test mode.

12. The mobile communication device of claim 11, wherein the processing unit further comprises:
a normal module, establishing a normal connection to one of the at least one local base station according to the local base station information to obtain the mobile communication service, wherein the determining module makes the mobile communication device utilize the normal module to obtain the mobile communication service through the normal connection when the present mode is determined under the normal mode.

13. The mobile communication device of claim 12, wherein the processing unit further comprises:
a switching module,
when the determining module determines that status of the test is abnormal, the switching module switches the present mode to the normal mode, such that the mobile communication device utilizes the normal module to obtain the mobile communication service through the normal connection.

14. The mobile communication device of claim 12, wherein the processing unit further comprises:
a switching module, wherein the switching module switches the present mode according to a mode switching signal when the mode switching signal is received, and the determining module selects one of the normal module and the test module to obtain the mobile communication service according to the switched present mode.

15. The mobile communication device of claim 11, further comprising:
a storage unit, wherein the test module analyzes status of the test connection and records the status of the test connection in the storage unit.

16. The mobile communication device of claim 11, further comprising:
a database, wherein the test module obtains identification information of the at least one base station from the at least one base station, and queries the database according to the identification information of the at least one base station to obtain the connection information.

17. The mobile communication device of claim 11, further comprising:
a user interface, wherein the connection information is obtained through the user interface.

18. The mobile communication device of claim 11, further comprising:
a computer transmission interface, building a connection with a computer, wherein the connection information is obtained from the computer through the computer transmission interface.

19. The mobile communication device of claim 11, wherein the processing unit further comprises:
an update module,
when an update short message, which comprises an update for the connection information, is received through short message service of the mobile communication service by the mobile communication unit, the update module updates the connection information according to the update for the connection information.

20. The mobile communication device of claim 11, wherein the processing unit further comprises:
an update module,
when the mobile communication unit connects to Internet through the mobile communication service and an update packet, which comprises an update for the connection information, is received through Internet, the update module updates the connection information according to the update for the connection information.
